(19) United States
(12) Patent Application Publication
(10) Pub. No.: US 2002/0107582 A1
(43) Pub. Date: Aug. 8, 2002

(54) Local area network for distributing controls to peripheral controllers on mechanized irrigation equipment

(76) Inventors: Ron Pollak, Elkhorn, NE (US); Bruce Kreikemeier, West Point, NE (US); Marv Schulz, Omaha, NE (US); Craig Malsam, Omaha, NE (US); Dave Mack, Omaha, NE (US)

Correspondence Address: THOMTE, MAZOUR & NIEBERGALL, L.L.C., 2120 S. 72ND STREET, SUITE 1111, OMAHA, NE, 68124, US

(21) Appl. No.: 09/778,505

(22) Filed: Feb. 7, 2001

(51) Int. Cl. G05B 11/01

(52) U.S. Cl. 700/19

(57) ABSTRACT

A Local Area Network (LAN) is disclosed for distributing control signals on a mechanized irrigation system. A master controller and a plurality of peripheral controllers are associated with the irrigation system. The master controller communicates and distributes control signals to the peripheral controllers over a Local Area Network (LAN).

### BACKGROUND OF THE INVENTION

1. Field of the Invention

This invention relates to the use of a Local Area Network (LAN) for distributing controls to peripheral controllers on mechanized irrigation equipment and more particularly to a Local Area Network which enables the number of conductors in the span cable to be substantially reduced and which reduces the time required to install a span cable on a multi-span system.

2. Description of the Related Art

The electrical and electromechanical controls for mechanized irrigation equipment are generally located in a single control panel. The inputs and outputs from the controls are routed to and from the panel through a large, multi-conductor cable. For center pivot irrigation systems, the conductors must be routed through a device positioned on the pivot structure which is known in the industry as a collector ring. The collector ring allows the cable on the span (span cable) to move in a continuous circular motion while fixed at the pivot without binding or twisting.

The installation of the span cable on a multi-span system requires numerous man-hours for assembly and is very expensive. Further, the collector ring consists of many sets of electrically conducting rings. A set of conducting rings maintains electrical contact as the surfaces of the rings slide against each other. One ring in the set is fixed and is used to connect the signal to the fixed pivot point. The other ring in the set is used to connect the wire to the span, which is moving in a circular motion. The collector ring is expensive and is subject to oxidation and corrosion which causes failure of the collector ring in many instances.

### SUMMARY OF THE INVENTION

A Local Area Network (LAN) is disclosed for distributing controls to peripheral controllers associated with a mechanized irrigation system. A master controller is provided at a central location and is electrically connected to a plurality of peripheral controllers associated with the irrigation system by means of a Local Area Network (LAN). Some of the peripheral controllers such as a motor controller, percent timer controller, end gun controller, corner controller, etc., are located on the system for movement therewith. Other peripheral controllers such as a pump controller, a valve controller, etc., are also controlled by the master controller through the LAN. The master controller communicates and distributes control signals to the peripheral controllers over the LAN with the LAN substantially reducing the number of conductors being required in the span cable.

A principal object of the invention is to provide a Local Area Network for distributing controls to peripheral controllers on a mechanized irrigation system.

A further object of the invention is to provide a Local Area Network which distributes control signals to peripheral controllers which are mounted on a mechanized irrigation system for movement therewith with the LAN substantially reducing the number of conductors required in the span cable.

A further object of the invention is to provide an invention of the type described above which simplifies the installation and reduces the cost of the span cable.

Yet another object of the invention is to provide an invention of the type described which reduces the collector ring requirements.

Still another object of the invention is to provide a LAN which results in improved signal quality of control signals being distributed to peripheral controllers.

Still another object of the invention is to provide a system of the type described above which provides flexibility for convenient expansion.

Still another object of the invention is to provide a Local Area Network for distributing controls from a master controller to peripheral controllers located on the mechanized irrigation equipment with the peripheral controllers being located at points in the mechanized irrigation system that provides the most flexibility, ease of installation, accessibility, cost effectiveness, etc.

These and other objects will be apparent to those skilled in the art.

### BRIEF DESCRIPTION OF THE DRAWINGS

FIG. 1 is a perspective view of a mechanized irrigation system utilizing the Local Area Network of this invention; and

FIG. 2 is a schematic of the Local Area Network of this invention.

### DESCRIPTION OF THE PREFERRED EMBODIMENT

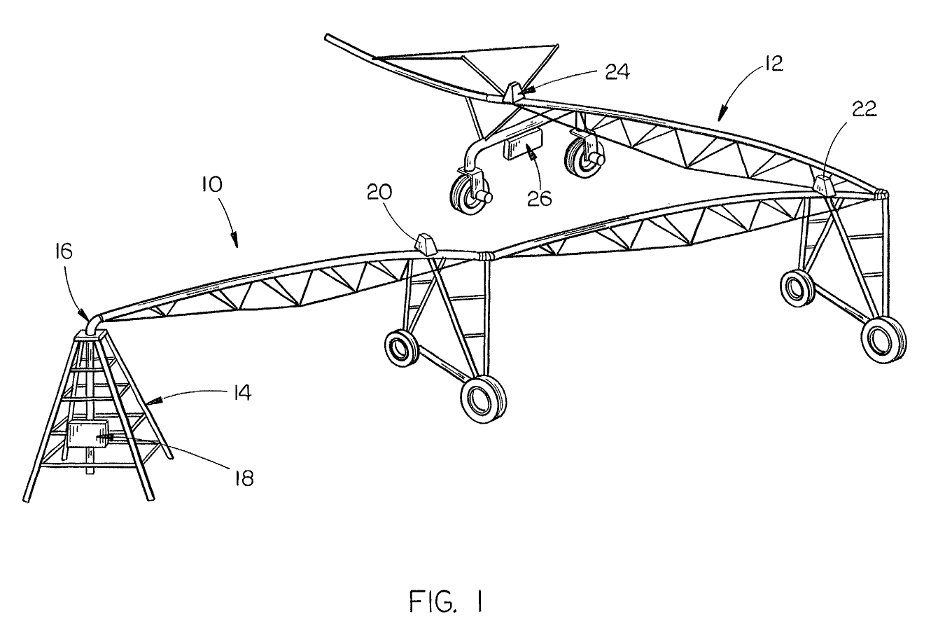

In FIG. 1, the numeral 10 refers generally to a mechanized irrigation system such as a center pivot irrigation system having a corner arm 12 attached thereto in conventional fashion for irrigating the corners of the field. The Local Area Network (LAN) described hereinafter may also be used on a mechanized linear irrigation system. The system 10 includes a center pivot structure 14 about which the system moves to irrigate the field. The irrigation system includes a plurality of conventional drive towers or units which are driven by electrical motors in conventional fashion. Pivot structure 14 includes a conventional collector ring 16 thereon which is adapted to provide electrical power to components on the pivoting irrigation system. The numeral 18 refers to a pivot controller (master controller) which is located on the pivot structure 14. The master controller 18 communicates and distributes control signals to peripheral controllers over a Local Area Network (LAN) as will now be described.

As stated, the master controller 18 is located at the pivot structure 14. Peripheral controllers are located at points on the irrigation system that provide the most flexibility, ease of installation, accessibility, cost effectiveness, etc. The master controller 18 communicates and distributes control signals to the peripheral controllers over the LAN. For purposes of description, the numeral 20 refers to a motor controller while the numeral 22 refers to a percent timer control. The numeral 24 refers to an end gun and booster pump control while the numeral 26 refers to a corner controller. Other peripheral controllers may also be located on the system as required. Further, peripheral controllers will also be utilized which are not mounted on the system for movement therewith such as a pump controller 28 and a valve controller 30. There may also be other peripheral controllers which will be utilized which will not be mounted on the system itself, but which will form a part of the system. A cable 31 extends from the master controller 18 to the input side 34 of the collector ring 16. Span cable 32 extends from the output side of the collector ring 16 and extends outwardly along the length of the system.

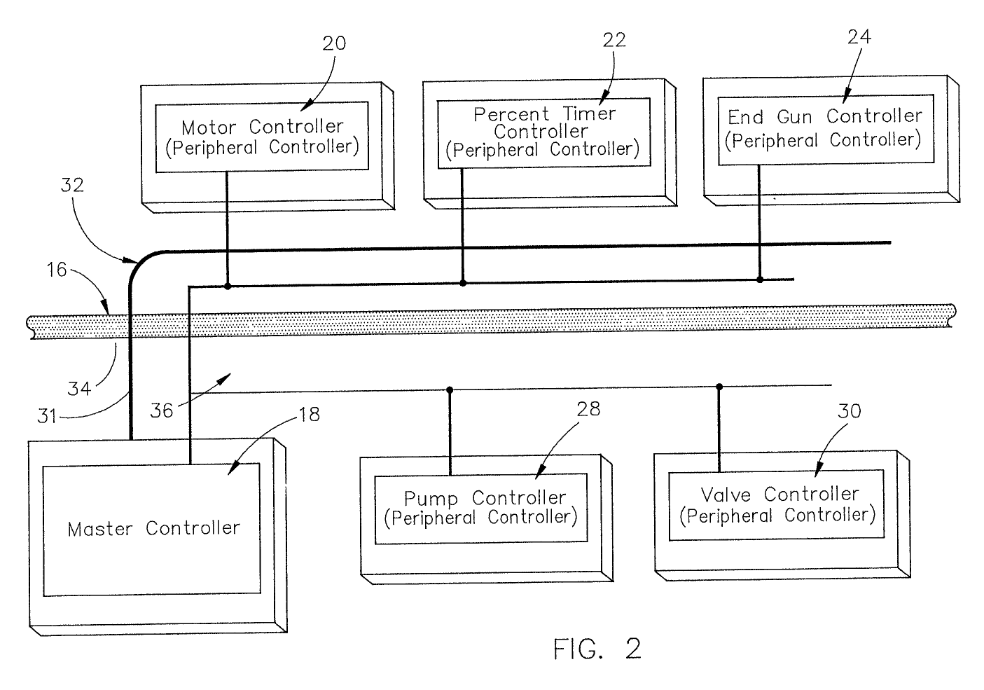

The numeral 36 refers to a Local Area Network (LAN) of conventional design which connects the master controller 18 and the peripheral controllers 20, 22, 24, 26, 28, and 30. The portion of the LAN which connects the master controller 18 to the peripheral controllers which move with the system extends to the input side 34 of the collector ring 16, as seen in FIG. 2. The LAN extends from the output side of the collector ring 16 within the span cable 32, as also seen in FIG. 2. Normally, the LAN will include multiple wires for communicating with and controlling the peripheral controllers. The peripheral controllers 20, 22 and 24 are connected to each of the multiple wires of the LAN 36 to enable the master controller 18 to communicate with and control the operation thereof. The peripheral controllers which are not mounted on the system, such as the pump controller 28 and the valve controller 30, are also connected to the multiple wires of the LAN 36 between the master controller 18 and the input side 34 of collector ring 16.

As described and shown, the controls for the irrigation system are divided into a master controller and many peripheral controllers. The master controller is located at a central point, with the peripheral controllers being located at points on the mechanized irrigation system that provide the most flexibility, ease of installation, accessibility, cost effectiveness, etc. As stated, the master controller 18 communicates and distributes control signals to the peripheral controllers over the LAN.

The use of the LAN significantly reduces the number of conductors required in the span cable 32. For example, on a typical center pivot irrigation system, the span cable may be reduced in number from 15-20 conductors to 5 conductors. This greatly simplifies installation and reduces cost. Further, the reduction in the number of conductors also reduces the collector ring requirements. The reduced number of collector rings results in reduced cost and increased reliability due to fewer opportunities for collector ring failure. Due to the fact that the peripheral controls are distributed along the irrigation system at locations in close proximity to the devices or elements being controlled, the signal wires extending from those controllers to the devices or elements being controlled can be kept relatively short. This results in improved signal quality due to lower line resistance and lower induced noise into the signal wires.

The LAN architecture also provides flexibility for convenient expansion. Devices, which are compatible on the LAN, can be added to the control system by attaching them to the LAN bus.

As stated hereinabove, the LAN is also well-suited for use on linear move irrigation systems.

Thus it can be seen that the invention accomplishes at least all of its stated objectives.

We claim:

1. In combination:
a mechanized irrigation system;
a master controller;
a plurality of peripheral controllers associated with said irrigation system;
said master controller communicating and distributing control signals to said peripheral controllers over a Local Area Network (LAN).

2. The combination of claim 1 wherein said mechanized irrigation system comprises a center pivot irrigation system which is driven by a plurality of drive motors.

3. The combination of claim 2 wherein one of said peripheral controllers comprises a motor controller which is electrically connected to said drive motors.

4. The combination of claim 2 wherein one of said peripheral controllers comprises a percent timer controller.

5. The combination of claim 2 wherein one of said peripheral controllers comprises an end gun controller.

6. The combination of claim 2 wherein one of said peripheral controllers comprises a booster pump controller.

7. The combination of claim 2 wherein said center pivot irrigation system includes a corner system and wherein one of said peripheral controllers comprises a corner controller.

8. The combination of claim 1 wherein one of said peripheral controllers comprises a pump controller.

9. The combination of claim 1 wherein one of said peripheral controllers comprises a valve controller.

10. The combination of claim 1 wherein at least some of said peripheral controllers are mounted on said irrigation system.

11. The combination of claim 1 wherein said mechanized irrigation system comprises a center pivot irrigation system including a center pivot having a collector ring mounted thereon which has an input side and an output side; said LAN extending from said master controller to said input side of said collector ring; a span cable extending from said output side of said collector ring along said center pivot irrigation system; said LAN extending from said output side of said collector ring in said span cable; at least some of said peripheral controllers being located on said center pivot irrigation system.

12. The combination of claim 11 wherein said center pivot irrigation system also includes peripheral controllers which are not mounted on said system.

13. The combination of claim 12 wherein said non-mounted peripheral controllers are connected to said LAN between said master controller and said input side of said collector ring.

14. The combination of claim 12 wherein one of said non-mounted peripheral controllers comprises a pump controller.

15. The combination of claim 12 wherein one of said non-mounted peripheral controllers comprises a valve controller.

16. The combination of claim 1 wherein said mechanized irrigation system comprises a linear move irrigation system.
